(19) United States
(12) Patent Application Publication
(10) Pub. No.: US 2015/0095078 A1
(43) Pub. Date: Apr. 2, 2015

(54) RESOURCE SCHEDULING BASED ON HISTORICAL SUCCESS RATE

(71) Applicant: International Business Machines Corporation, Armonk, NY (US)

(72) Inventors: Adam D. Braham, Rochester, MN (US); Dennis D. Koski, Oronoco, MN (US); Doyle J. McCoy, Rochester, MN (US); Jeffrey A. Schmidt, Rochester, MN (US)

(73) Assignee: International Business Machines Corporation, Armonk, NY (US)

(21) Appl. No.: 14/039,123

(22) Filed: Sep. 27, 2013

(51) Int. Cl. G06Q 10/06

(52) U.S. Cl. CPC G06Q 10/063112
USPC 705/7.14

(57) ABSTRACT

An approach for resource scheduling of teams based on historic performance evaluations of projects of the teams. In one aspect, the approach comprises monitoring resource skills of one or more teams based on historical performance of previous problems solved by the one or more teams. The approach further comprises, evaluating success rates of the one or more team's effectiveness in utilizing the resource skills based on the historical performance of the previous problems solved. The approach further comprises determining a resource schedule for a new problem solved by the one or more teams based on the success rates of the team's effectiveness in utilizing the resource skills of the previous problems solved. The approach further comprises modifying the determined resource schedule based on altered conditions of the success rates of the one or more team's effectiveness in utilizing the resource skills over a duration of time.

### FIELD OF THE INVENTION

The present invention relates generally to scheduling systems in team workflow environments, and more particularly to management and monitoring of resource schedules based on historical performance evaluations, or success rates of previous problems, or historical records of workflows performed by workgroups or teams.

### BACKGROUND

In a customer support environment with global teams, having an optimal balance technical and language skills to address or solve a given problem can be difficult. For example, some resources are reliable in solving the given problem, and other resources can be less reliable in solving the problem. Further success rates are typically utilized by computing systems to determine how a future team would be optimized to better handle resource problems with a better balance of the skills needed. In some cases, a resource with a necessary skill may not be available, and a concession would have to be made to address the given problem being solved. In this case, the computing system may route the given problem to be solved to someone with a less than ideal skill. However, this may result in a longer time to resolve the problem, and a corresponding lower customer satisfaction rating.

### SUMMARY

In one embodiment, a method is provided for resource scheduling of teams based on historic performance evaluations of projects of the teams. The method comprises monitoring, by one or more processors, resource skills of one or more teams based on historical performance of previous problems solved by the one or more teams. The method further comprises evaluating, by the one or more processors, success rates of the one or more team's effectiveness in utilizing the resource skills based on the historical performance of the previous problems solved. The method further comprises determining, by the one or more processors, a resource schedule for a new problem solved by the one or more teams based on the success rates of the team's effectiveness in utilizing the resource skills of the previous problems solved. The method further comprises modifying, by the one or more processors, the determined resource schedule based on altered conditions of the success rates of the one or more team's effectiveness in utilizing the resource skills over a duration of time.

In another embodiment, a computer system is provided for resource scheduling of teams based on historic performance evaluations of projects of the teams. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises, program instructions to monitor resource skills of one or more teams based on historical performance of previous problems solved by the one or more teams. The computer system further comprises, program instructions evaluate, success rates of the one or more team's effectiveness in utilizing the resource skills based on the historical performance of the previous problems solved. The computer system further comprises, program instructions to determine a resource schedule for a new problem solved by the one or more teams based on the success rates of the team's effectiveness in utilizing the resource skills of the previous problems solved. The computer system further comprises program instructions to modify the determined resource schedule based on altered conditions of the success rates of the one or more team's effectiveness in utilizing the resource skills over a duration of time.

In yet another embodiment, a computer program product is provided for resource scheduling of teams based on historic performance evaluations of projects of the teams. The computer program product comprises one or more computer-readable tangible storage devices and program instructions stored on at least one of the one or more storage devices. The computer program product further comprises program instructions to monitor resource skills of one or more teams based on historical performance of previous problems solved by the one or more teams. The computer program product further comprises program instructions evaluate, success rates of the one or more team's effectiveness in utilizing the resource skills based on the historical performance of the previous problems solved. The computer program product further comprises program instructions to determine a resource schedule for a new problem solved by the one or more teams based on the success rates of the team's effectiveness in utilizing the resource skills of the previous problems solved. The computer program product further comprises program instructions to modify the determined resource schedule based on altered conditions of the success rates of the one or more team's effectiveness in utilizing the resource skills over a duration of time.

### BRIEF DESCRIPTION OF THE SEVERAL VIEWS OF THE DRAWINGS

Novel characteristics of the invention are set forth in the appended claims. The invention will best understood by reference to the following detailed description of the invention when read in conjunction with the accompanying figures, wherein like reference numerals indicate like components, and:

FIG. 1 is a functional system diagram of resource scheduling system for analyzing resource skills of workgroups or teams in accordance with embodiments of the present invention.

FIG. 2 depicts a block diagram of components of a computer system, in accordance with embodiments of the present invention.

FIG. 3 is a functional system diagram illustrating components of client device 110, in accordance with an embodiment of the present invention.

FIG. 4 depicts a block diagram of recourse skills log table that stores recorded information, in accordance with embodiments the present invention.

FIG. 5 is a functional block diagram illustrating components of server device in accordance with an embodiment of the present invention.

FIG. 6 depicts a block diagram of a resource scheduling recommendation table, which is analyzed by optimal schedule modification engine based on resource skills, in accordance with embodiments of the present invention.

FIG. 7 is a flow diagram of a method for resource scheduling of teams based on historic performance evaluations of projects of the teams in accordance with one embodiment of the present invention.

### DETAILED DESCRIPTION

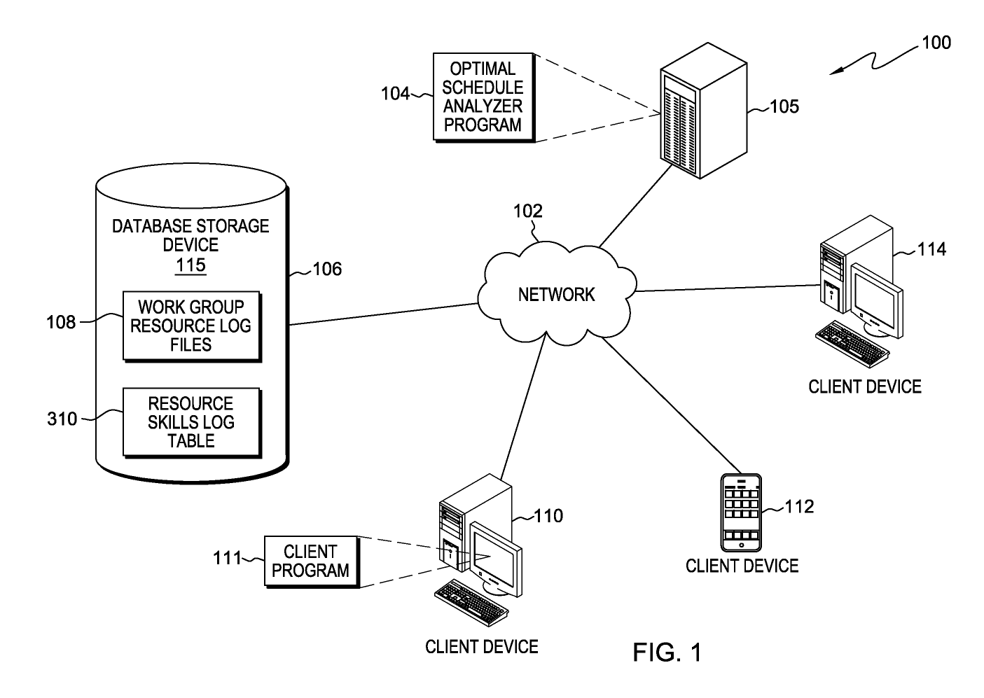

The present invention will now be described in details with reference to the accompanying Figures. Referring to FIG. 1, resource scheduling system 100 for analyzing resource skills of workgroups or teams, based on historical performance evaluations, or success rates of previous problems or historical records of workflows performed by the workgroups is shown. According to at least one embodiment of the present invention, resource scheduling system 100 provides an optimal schedule of the workgroups based on the analyzed resource skills, and the historical performance of the previous problems for a problem being solved. The resource skills can be individual personnel workgroup parameters, including for example, language skills of the workgroups, geography locations of the workgroups, or technical skills of the workgroups, that are needed to perform the problem being solved. Another embodiment of the present invention includes a dynamic real time scheduler that modifies an already defined schedule of the workgroups based on dynamic or unintentional modifications, or changes to the parameters or conditions of the resource skills or historical performance for the problem being solve by the workgroups or teams of resource scheduling management system 100.

Resource scheduling system 100 includes client devices 110, 112, 114, server system 105 and database storage device 115. Server system 105, database storage device 115, and client devices 110, 112, 114 are interconnected over network 102. Client devices 110, 112, 114, can be for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Each of client devices 110, 112 comprises client program 111.

Client program 111 acquires resource skills of workgroups or teams, based on historical performance evaluations, or success rates of previous problems or historical records of workflows performed by the workgroups, and transmits the acquired resource skills to an optimal scheduler of server device 105, wherein the optimal scheduler analyzes the acquired resource skills, and provides an optimal schedule of the workgroups based on the analyzed resource skills, and the historical performance evaluations of a previous problem for a problem being solved, as described below, in accordance with embodiments of the present invention.

Server system 105 can be a resource management server, a web server, or any other electronic device, or computing system capable of transmitting acquired data from client devices 110, 112, 114, and processing the acquired data based on resource skills of workgroups, or teams, including for example, historical performance evaluations, or success rates of previous problems or historical records of workflows performed by the workgroups. Server system 105 includes optimal schedule analyzer program 104.

Optimal schedule analyzer program 104 can be software residing on a resource management server that analyzes the resource skills of workgroups and provides an optimal schedule of the workgroups based on analyzed resource skills, including for example, historical performance evaluations, or success rates of previous problems or historical records of workflows performed by the workgroups for a problem being solved by the workgroups.

Server system 105 can also represent a “cloud” of computers interconnected by one or more networks, wherein server system 105 can be a primary server of a computing system utilizing clustered computers when accessed through network 102. For example, a cloud computing system can be an implementation of transmission of optimal schedule of the workgroups based on analyzed resource skills and the historical performance for a problem being solved by the workgroups, in accordance with embodiments of the present invention.

Database storage device 115 can be any type of storage device, storage server, storage area network, redundant array of independent discs (RAID), cloud storage device, or any type of data storage that maintains information that relates to resource skills of workgroups, or teams, including for example, historical performance evaluations, or success rates of previous problems or historical records of workflows performed by the workgroups.

Database storage device 115 can be for example, DB2® (DB2 is a registered trademark of International Business Machines Corporation in the United States, other countries or both). DB2® can be relational model database server. The relational model for database management of database storage device is a database model based on first-order predicate logic. In the relational model of a database, all data is represented in terms of tuples, grouped into relations. For example, a database organized in terms of the relational model is a relational database. A relation of the relational model is defined as a set of tuples that have the same attributes. As described, database storage device 115 further includes work group resources log files 108. Work group resources log files 108 includes information pertaining to analyzed resource skills of the work groups for a problem being solved, as described below, in accordance of the present invention. The stored analyzed resource skills of work group resources log files 108 provides retrieval of information of historical performance evaluations, or success rates of previous problems or historical records of workflows performed by the workgroups of resource scheduling system 100, in accordance with embodiments of the present invention. Database storage device 115 also includes recourse skills log table 310 which stores recorded time, skills/language, net skill, and concession or surplus of recorded monitored inputs of the workgroups or teams based on previous success of previous problems that were solved by the workgroups of teams, in accordance with embodiments the present invention.

Network 102 includes one or more networks of any kind that can provide communication links between various devices and computers connected together within print management system 100. Network 102 also includes connections, such as wired communication links, wireless communication links, or fiber optic cables. Furthermore, network 102 can be implemented as a number of different types of networks, including for example, a local area network (LAN), wide area network (WAN) or a packet switched telephone network (PSTN), or some other networked system. Network 102 can include the Internet representing a worldwide collection of networks.

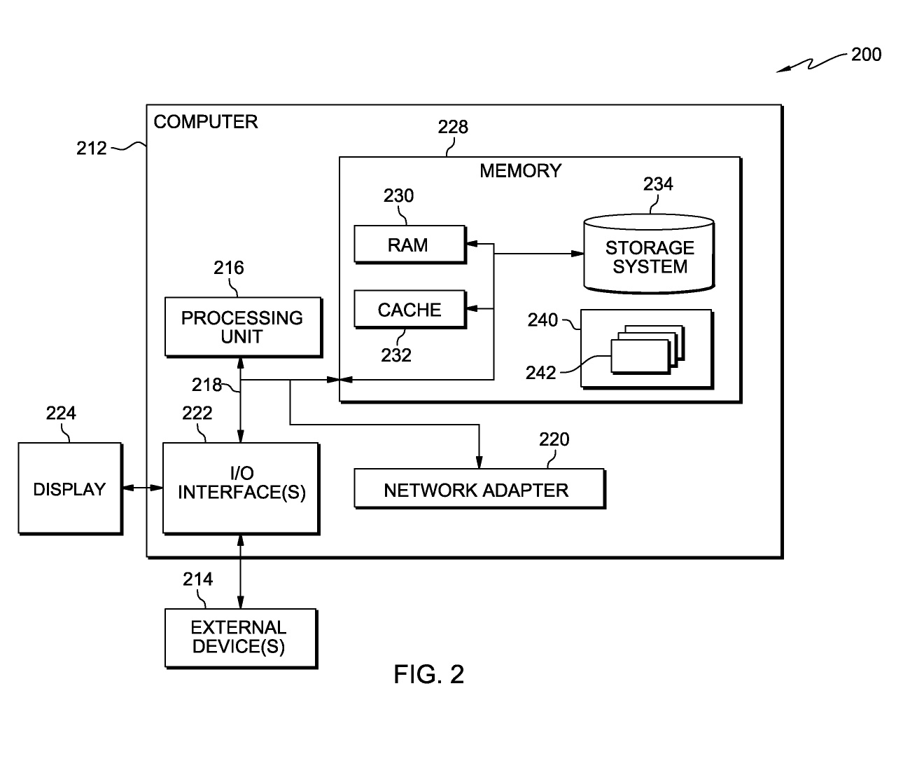

FIG. 2 depicts a block diagram of components of a computer system, in accordance with embodiments of the present invention.

Computer system 200 is only one example of a suitable computer system and is not intended to suggest any limitation as to the scope of use or functionality of embodiments of the invention described herein. Regardless, computer system 200 is capable of being implemented and/or performing any of the functionality set forth hereinabove. In computer system 200 there is computer 212, which is operational with numerous other general purpose or special purpose computing system environments or configurations. Examples of well-known computing systems, environments, and/or configurations that may be suitable for use with computer 212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Client devices 110, 112, 114 and server device 105 can be implemented as an instance of computer 212.

Computer 212 may be described in the general context of computer system executable instructions, such as program modules, being executed by a computer system. Generally, program modules may include routines, programs, objects, components, logic, data structures, and so on that perform particular tasks or implement particular abstract data types. Computer 212 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 2, computer 212 is shown in the form of a general-purpose computing device. The components of computer 212 may include, but are not limited to, one or more processors or processing units 216, memory 228, and bus 218 that couples various system components including memory 228 to processing unit 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 212 typically includes a variety of computer system readable media. Such media may be any available media that is accessible by computer 212, and includes both volatile and non-volatile media, and removable and non-removable media.

Memory 228 includes computer system readable media in the form of volatile memory, such as random access memory (RAM) 230 and/or cache 232. Computer 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Client program 111 and optimal schedule analyzer program 104 can be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein. Client program 111 and optimal schedule analyzer program 104 can be implemented as an instance of program 240.

Computer 212 may also communicate with one or more external devices 214 such as a keyboard, a pointing device, etc., as well as display 224; one or more devices that enable a user to interact with computer 212; and/or any devices (e.g., network card, modem, etc.) that enable computer 212 to communicate with one or more other computing devices. Such communication occurs via Input/Output (I/O) interfaces 222. Still yet, computer 212 communicates with one or more networks such as a local area network (LAN), a general wide area network (WAN), and/or a public network (e.g., the Internet) via network adapter 220. As depicted, network adapter 220 communicates with the other components of computer 212 via bus 218. It should be understood that although not shown, other hardware and/or software components could be used in conjunction with computer 212. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that in some alternative implementations, the functions noted in the block may occur out of the order noted in the Figures. For example, two blocks shown in succession may in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

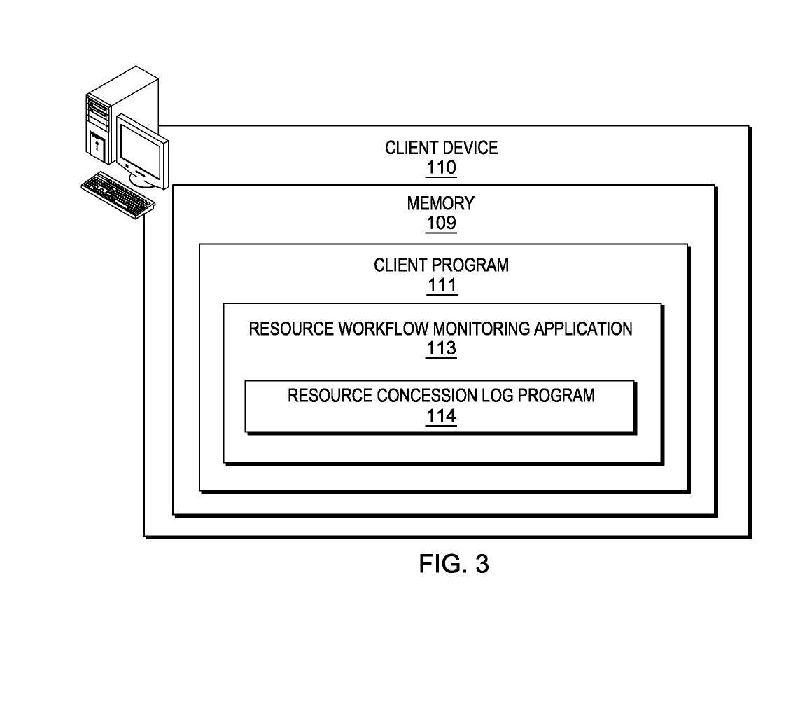

FIG. 3 is a functional system diagram illustrating components of client device 110, in accordance with an embodiment of the present invention.

Client device 110 includes memory 109. Memory 109 may comprise, for example, one or more computer-readable storage media, which may include random-access memory (RAM) such as various forms of dynamic RAM (DRAM), e.g., DDR2 SDRAM, or static RAM (SRAM), flash memory, or any other form of fixed or removable storage medium that can be used to carry or store desired program code and program data in the form of instructions or data structures and that can be accessed by other components of client device 110. Memory 109 operates client program 111.

Client computer program 111 can among other things, retrieve and display content accessible via network 102, such as, resource scheduling workflows, resources skills web page attributes, resources workflow log monitoring tables, or work group historical performance pages of resource scheduling system 100. Client program 111 can also be a web browser. Examples of web browsers include Internet Explorer® (Internet Explorer is a trademark of Microsoft Inc., in the United States, other countries or both), Firefox® (Firefox is a trademark of Mozilla Corporation, in the United States other countries, or both), Safari® (Safari is a trademark of Apple, Inc. in the United States, other countries, or both) and Google Chrome™ (Google Chrome is a trademark of Google, Inc. in the United States, other countries, or both), respectively. Client program 111 can also be a standalone web page search application, or part of a service that monitors and interacts with a web browser or web page search application. Client program 111 includes resource workflow monitoring application 113. Resource workflow monitoring application 113 can be a web browser plugin/add-on that extends the functionality of client program 111 by adding additional user interface elements to a user interface of client program 111. For example, resource workflow monitoring application 113 can include program code, such as, HyperText Markup Language (HTML) code or JavaScript code that, when executed, adds the additional user interface elements to the user interface of client program 111.

The additional user interface elements of resource workflow monitoring application 113 monitors resource skills, including for example, language skills of the workgroups, geography locations of the workgroups, or technical skills of the workgroups, based on historical performance evaluations, or success rates of previous problems or historical records of workflows performed by the workgroups over a period or duration of time. For example, resource workflow monitoring application 113 monitors program executions of client program 111 of the resources skills of the workgroups, periodically, randomly, and/or using event-based monitoring, and stores the monitored resource skill in database storage device 115 for transmittal to optimal schedule analyzer program 104. As described, optimal schedule analyzer program 104 analyzes the monitored resource skills, and provides an optimal schedule of the workgroups based on analyzed resource skills and the historical performance for a problem being solved by the workgroups, in accordance with embodiments of the present invention.

Resource workflow monitoring application 113 includes resource concession log program 114. Resource concession log program 114 records, and provides monitored and stored inputs of available resources logs of previous success rates of previous problems that were solved by the workgroups of teams. The recorded monitored inputs of resource concession log program 114 includes, for example, time stamp of when the previous problem was assigned, skills of the workgroup or team the problem was assigned to, and skills surplus or deficit of the workgroup or team that the previous problem was assigned. According to at least one embodiment, the recorded monitored input of resource concession log program 114 also considers availability of the work group, or teams that are available to embark and solve the new problem. The monitored inputs of resource concession log program 114 are stored in work group resource log files 108, and accessible by optimal schedule analyzer program 104 for analyzing the resource skills of the monitored inputs of resource concession log program 114 based on the analyzed resource skills of the workgroups, including for example, historical performance evaluations, or success rates of previous problems or historical records of workflows performed by the workgroups for a problem being solved by the workgroups.

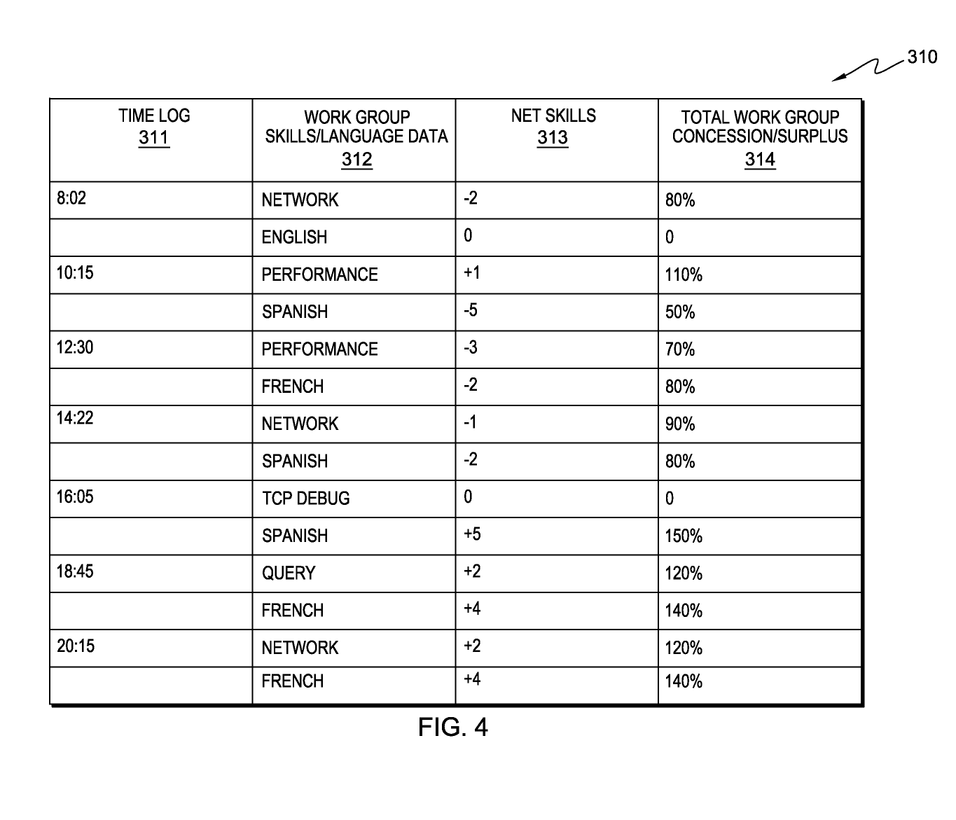

FIG. 4 depicts a block diagram of recourse skills log table 310 that stores recorded information, in accordance with embodiments the present invention. Resource concession log program 114 dynamically monitors resource skills log table 310 to determine availability of logs of previous success rates of resource skills of the workgroup or teams.

Resource skills log table 310 is stored in database storage device 115, wherein the stored resource skills log table 310 is dynamically updated with information pertaining to concession rates, including time, assigned skill, net skill and concession or surplus of skills of previous problems of work groups or teams. Resource skills log table 310 includes, time log 311, work group skills/language data 312, net skills 313, and total work group concession/surplus 314. Time log 311 represents specific time stamp or time frame of when a previous work was assigned to the work group or team. Time log 311 can also represent specific time the work group or team was available to solve the previous problem. Consider for example, that the previous work was completed over an eight hour period, also consider that the specific work group or team that worked on the previous problem was at a specific time based on availability. In this manner, information pertaining to time period the work was completed, and the time period of available of the work group or team is logged in time log 311 by resource concession log program 114, and stored in database storage device 115 for future retrieval of the logged time table of resource skill log table 310 during resource scheduling of a problem.

Resource concession log program 114 also transmits information pertaining to time period the work was completed, and the time period of available of the work group or team is logged in time table 311 to optimal schedule analyzer program 104, wherein optimal schedule analyzer program 104 analyzes and provides an optimal schedule of the workgroups based on analyzed resource skills, and the historical performance for a problem being solved by the workgroups. Work group skills/language log 312 includes information pertaining to technical skills of the work group, or teams during the previous problem solved, language skills of the work group or teams pertaining to the previous problem, or production efficiency skills of the work group or teams regarding the previous problem.

According to at least one embodiment, net skills 313 represents skill surplus or skills deficit of work groups or teams based on resource skill available to work on the new problem. In the depicted environment of resource skills log table 310, a negative work group skill concession implies optimal schedule analyzer program 104 of server device 105 assigned a previous work to a lower than desired work group skills log, and logged the amount of skill concession that was made. On the other hand, a positive net skill log includes a rate assigned if the workflow method assigned a lower skill work item to a higher work group skill, thus capturing an overflow in the skill for that particular workflow assignment. Moreover, in another example, if resource log concession program 114 determines that a particular work group or team was assigned a lower skill than was optimal, resource log concession program 114 logs a negative net skill log. However, if resource log concession program 114 determines that a particular work group or team was assigned a higher net skill than was necessary to solve the previous issue, the net skills of the work group or team are assigned a positive value.

Further, the number recorded can be any factor relating to the net skills of the work group or team based on the previous skills and the problem been solved. According to aspects of the present invention, consider a team with finite resources, including workgroups or teams, we could analyze the past success/concession rates of the team or workgroups based on how many resources of the work group or teams were being utilized for a required skill of a problem over a given time frame. For example, if recourse skills log table 310 stores a fixed team of ten (10) resources, including teams or workgroups, wherein the team or workgroups include one or more skills. If a problem to be solved requires a specific skill to resolve it, recourse skills log table 310 tracks how many skills were utilized by the ten resources over a given time frame.

Further, if we consider language needed to resolve a problem, recourse skills log table 310 includes a historical log of how many problems were not assigned to a skill or resource because that skill was already utilized or not available at all at that time period. This would be a negative value or concession of the non assigned skill or resource for the particular problem. Also, consider for example, a given problem of five resources, including for example, five work groups or teams that speak Spanish, however, recourse skills log table 310 only includes two problems requiring Spanish over a given time period, in this case recourse skills log table 310 has a surplus of three Spanish skills that were not utilized for that specific language skill of the given problem. Further, a zero gain or loss of net skills 313 implies that recourse skills log table 310 had an exact amount of resources skill needed to match problems to be solved over that time frame of the required problem to be solved. According to another embodiment, also consider resource concession log program 114 assigns an incoming problem to a resource with a specific level of a skill or skill needed to solve the problem. Based on information in table, resource concession log program 114 measures how effective they were at solving that problem based on, for example, a time to resolution measurement, or based on how accuracy of resolution of the problem that was solved. For example, if the resource took longer than expected or they didn't solve the problem at a high percentage, we would say they had a concession from optimal or negative. However, if the workgroup or team solved the problem faster than expected or we could say we had a surplus or positive concession. The net skill column of +5 or −5, or % concession/surplus would really just be the output of this calculation.

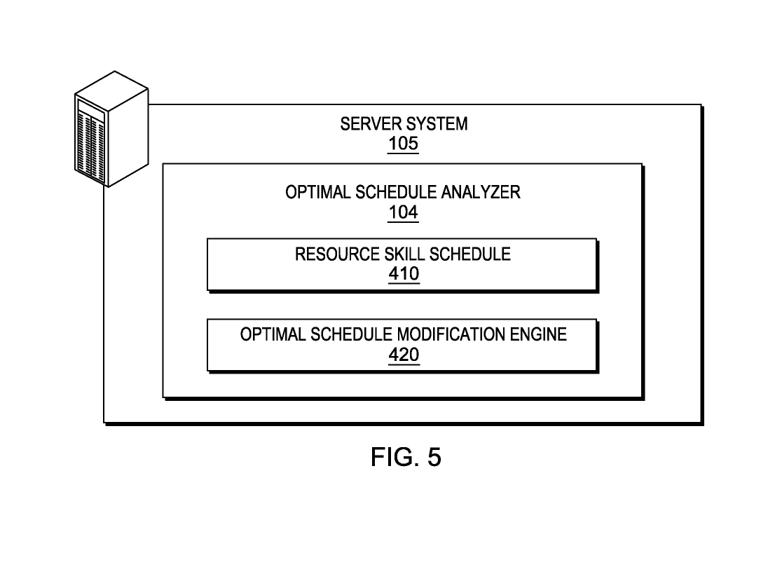

FIG. 5 is a functional block diagram illustrating components of server device 105 in accordance with an embodiment of the present invention. Server device 105 comprises optimal schedule analyzer program 104, in accordance with embodiments of the present invention. According to at least one embodiment, optimal schedule analyzer program 104 can be software residing on a resource management server that analyzes previous success rates of previous problems that were solved by the workgroups of teams by resource log program and provides an optimal schedule of the workgroups based on analyzed resource skills, and the historical performance for a problem being solved by the workgroups. Optimal schedule analyzer program 104 includes resource skill scheduler 410, and optimal schedule modification engine 420.

Resource skill scheduler 410 obtains a transmission of stored inputs of available log of previous success rates of solved previous success rates of previous problems that were solved by the workgroups of teams by resource concession log program 114, and identifies an optimal balance of skill needed for future resource scheduling. For example, according to at least one embodiment, resource skill scheduler 410 can identify the optima balance of skills needed to solve the problem based on a time stamp or time frame of when a previous work was assigned to the work group or team. As described above, time log 311 can also represent specific time the work group or team was available to solve the previous problem, as described above. For example, according to at least one embodiment, identification of skills by resource skill scheduler 410 can provide identification of skills where the skills might be over staffed, or the wherein availability of skills is understaffed, as described above. Resource skill schedule 410 thus provides a balance of a team of various skills to the optimized number for the given time frames, which is utilized by optimal schedule analyzer to analyze previous success rates of previous problems that were solved by the workgroups of teams by resource concession log program 114, in accordance with embodiments of the present invention.

Optimal schedule modification engine 420 dynamically provides a dynamic real time scheduler that modifies an already defined schedule of the workgroups based on dynamic or unintentional modifications, or changes to the parameters or conditions of the resource skills or historical performance for the problem being solve by the workgroups or teams of resource scheduling management system 100. For example, while historical data of the skills and problems solved are accurate, a new problem may come in that focuses on a specific skill. For instance, if a deficit in a certain skill in a recent time frame is experienced, optimal schedule analyzer would dynamically require more skills to be obtained in that specific area. For instance, optimal schedule modification engine 420 could adapt at an almost real time level to changing conditions as new problems arise.

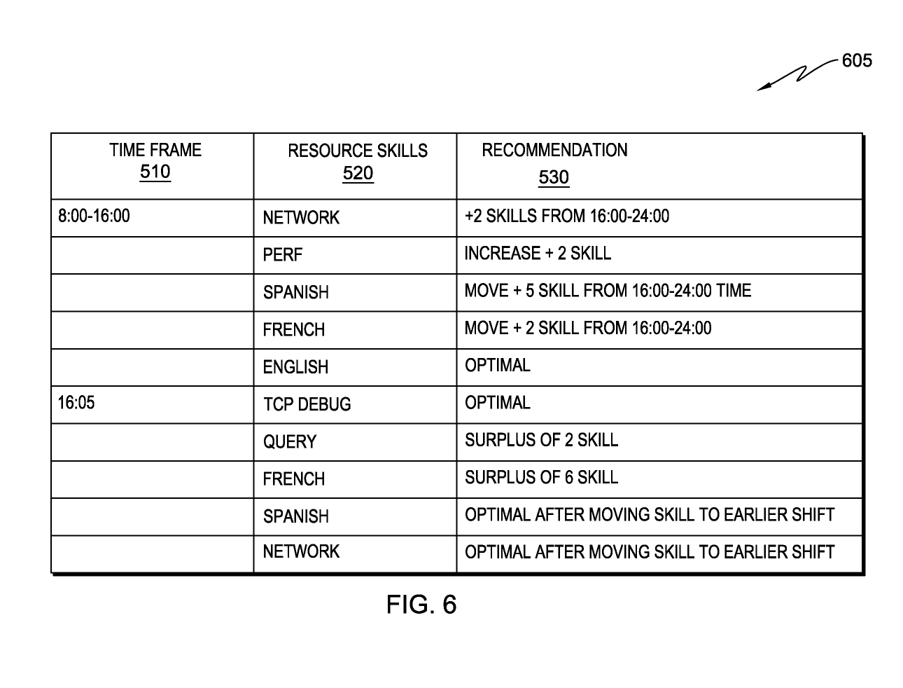

FIG. 6 depicts a block diagram of resource scheduling recommendation table 605, which is analyzed by optimal schedule modification engine based on resource skills, in accordance with embodiments of the present invention

Resource skills scheduling recommendation table 605 is analyzed by optimal schedule modification engine 420 based on resource skills of the monitored inputs of resource concession log program 114 based on the analyzed resource skills of the monitored inputs of resource concession log program 114, and providing an optimal schedule of the workgroups based on analyzed resource skills, including, for example, historical performance evaluations, or success rates of previous problems or historical records of workflows performed by the workgroups for a problem being solved by the workgroup. According to at least one embodiment, in the depicted environment of resource skills scheduling recommendation table 605, resource skill schedule 410 provides time frame 510 for the available resource skills to solve the problem, available resources skills 520 for the problem, and recommendation 530 of available resources skills that can solve or address a problem being solved, based on time frame 510 and resource skills 520.

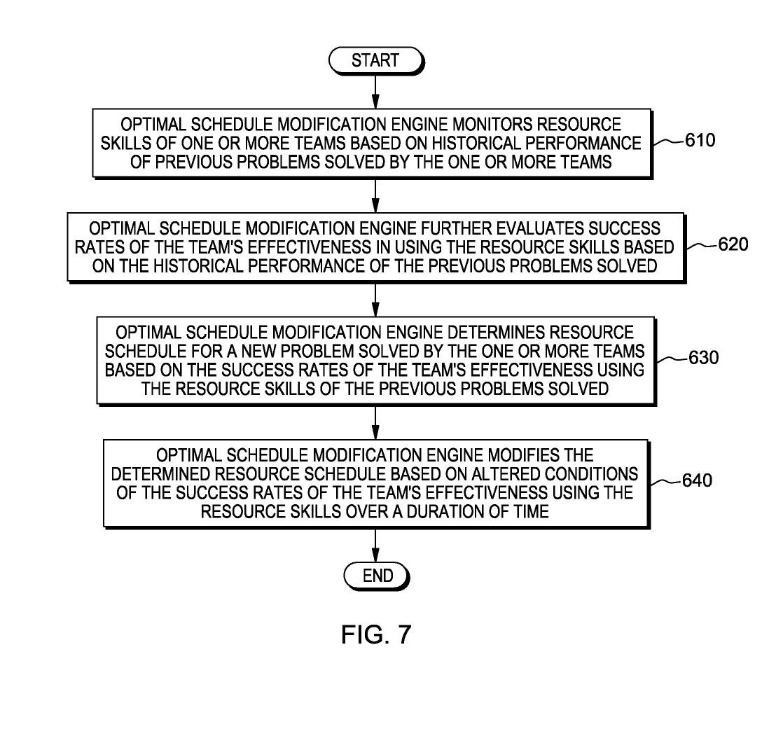

FIG. 7 is an exemplary flow diagram of a method for resource scheduling of teams based on historic performance evaluations of projects of the teams in accordance with one embodiment of the present invention. According to at least one embodiment, optimal schedule modification engine 420 monitors resource skills of one or more teams based on historical performance of previous problems solved by the one or more teams (Step 610). For example, optimal schedule modification engine 420 obtains monitored inputs of resource skills of resource concession log program 114 that are stored in work group resource log files 108 and accessible by optimal schedule analyzer program 104 for analyzing the resource skills of the monitored inputs of resource concession log program based on the analyzed resource skills of the monitored inputs, and providing an optimal schedule of the workgroups based on analyzed resource skills, including for example, historical performance evaluations, or success rates of previous problems or historical records of workflows performed by the workgroups for a problem being solved by the workgroup.

Optimal schedule modification engine 420 further evaluates success rates of the team's effectiveness in using the resource skills based on the historical performance of the previous problems solved (Step 620). For example, optimal schedule modification engine 420 obtains transmittal of log records of the success rates of the team's effectiveness using the resource skills of the previous problems solved from and based on the transmitted log records from resource concession log program, and calculates by a net sum or deficit variables of the log records of success rates of the team's effectiveness using the resource skills of the previous problems solved based on time frame of when the problem was assigned, the resource skill the problem was assigned to, and resource skills available to a solve the new problem solved. Optimal schedule modification engine 420 determines resource schedule for a new problem solved by the one or more teams based on the success rates of the team's effectiveness using the resource skills of the previous problems solved (Step 630). Optimal schedule modification engine 420 modifies the determined resource schedule based on altered conditions of the success rates of the team's effectiveness using the resource skills over a duration of time (Step 640).

Based on the foregoing a method for resource scheduling of teams based on historic performance evaluations of projects of the teams have been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A method for resource scheduling of teams based on historic performance evaluations of projects of the teams, the method comprising the steps of:
monitoring, by one or more processors, resource skills of one or more teams based on historical performance of previous problems solved by the one or more teams;
evaluating, by the one or more processors, success rates of the one or more team's effectiveness in utilizing the resource skills based on the historical performance of the previous problems solved; and
determining, by the one or more processors, a resource schedule for a new problem solved by the one or more teams based on the success rates of the team's effectiveness in utilizing the resource skills of the previous problems solved.

2. The method according to claim 1, further comprising the steps of:
transmitting, by the one or more processors, log records of the success rates of the one or more team's effectiveness in utilizing the resource skills of the previous problems solved; and
calculating, by the one or more processors, net sum or deficit variables of the log records of success rates of the one or more team's effectiveness in utilizing the resource skills of the previous problems solved based on time frame of when the problem was assigned, the resource skill the problem was assigned to, and resource skills available to a solve the new problem solved.

3. The method according to claim 2, wherein the net sum or deficit variables of the log records of success rates of the one or more team's effectiveness in utilizing the resource skills of the previous problems solved are calculated based on information in a log table which maintains an existing workflow application of the resource skill in a repository.

4. The method according to claim 2, wherein a negative concession of the calculated net sum or deficit variables of the log records of success rates of the one or more team's effectiveness in utilizing the resource skills of the previous problems solved implies that the previously assigned work was assigned to a lower than required skill.

5. The method according to claim 2, wherein a positive concession of the calculated net sum or deficit variables of the log records of success rates of the one or more team's effectiveness in utilizing the resource skills of the previous problems solved implies that previously assigned work was assigned to a higher resource skill, thus identifying an overflow in skill for a particular workflow assignment of the previously assigned work.

6. The method according to claim 1, further comprising the step of:
modifying, by the one or more processors, the determined resource schedule based on altered conditions of the success rates of the one or more team's effectiveness in utilizing the resource skills over a duration of time.

7. The method according to claim 1, further comprising the step of: monitoring, by the one or more processors, success rates of the one or more team's effectiveness in utilizing the resource skills based on the historical performance of the previous problems solved over the duration of time period.

8. A computer system for resource scheduling of teams based on historic performance evaluations of projects of the teams, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to monitor resource skills of one or more teams based on historical performance of previous problems solved by the one or more teams;
program instructions evaluate, success rates of the one or more team's effectiveness in utilizing the resource skills based on the historical performance of the previous problems solved; and
program instructions to determine a resource schedule for a new problem solved by the one or more teams based on the success rates of the team's effectiveness in utilizing the resource skills of the previous problems solved.

9. The computer system according to claim 8, further comprises:
program instructions to transmit log records of the success rates of the one or more team's effectiveness in utilizing the resource skills of the previous problems solved; and
program instructions to calculate net sum or deficit variables of the log records of success rates of the one or more team's effectiveness in utilizing the resource skills of the previous problems solved based on time frame of when the problem was assigned, the resource skill the problem was assigned to, and resource skills available to a solve the new problem solved.

10. The computer system according to claim 9, wherein the net sum or deficit variables of the log records of success rates of the team's effectiveness using the resource skills of the previous problems solved are calculated based on information in a log table which maintains an existing workflow application of the resource skill in a repository.

11. The computer system according to claim 9, wherein a negative concession of the calculated net sum or deficit variables of the log records of success rates of the team's effectiveness using the resource skills of the previous problems solved implies that the previously assigned work was assigned to a lower than required skill.

12. The computer system according to claim 9, wherein a positive concession of the calculated net sum or deficit variables of the log records of success rates of the team's effectiveness using the resource skills of the previous problems solved implies that previously assigned work was assigned to a higher resource skill, thus identifying an overflow in skill for a particular workflow assignment of the previously assigned work.

13. The computer system of claim 8 further comprises: program instructions to modify the determined resource schedule based on altered conditions of the success rates of the one or more team's effectiveness in utilizing the resource skills over a duration of time.

14. The computer system of claim 8 further comprises: program instructions to monitor success rates of the team's effectiveness in utilizing the resource skills based on the historical performance of the previous problems solved over a duration of time period.

15. A computer program product for resource scheduling of teams based on historic performance evaluations of projects of the teams, the computer program product comprising:
one or more computer-readable tangible storage devices and program instructions stored on at least one of the one or more storage devices, the program instructions comprising:
program instructions to monitor resource skills of one or more teams based on historical performance of previous problems solved by the one or more teams;
program instructions evaluate, success rates of the one or more team's effectiveness in utilizing the resource skills based on the historical performance of the previous problems solved; and
program instructions to determine a resource schedule for a new problem solved by the one or more teams based on the success rates of the team's effectiveness in utilizing the resource skills of the previous problems solved.

16. The computer program product according to claim 15, further includes:
program instructions to transmit log records of the success rates of the one or more team's effectiveness in utilizing the resource skills of the previous problems solved; and
program instructions to calculate net sum or deficit variables of the log records of success rates of the one or more team's effectiveness in utilizing the resource skills of the previous problems solved based on time frame of when the problem was assigned, the resource skill the problem was assigned to, and resource skills available to a solve the new problem solved.

17. The computer program product according to claim 16, wherein the net sum or deficit variables of the log records of success rates of the team's effectiveness using the resource skills of the previous problems solved are calculated based on information in a log table which maintains an existing workflow application of the resource skill in a repository.

18. The computer program product according to claim 16, wherein a negative concession of the calculated net sum or deficit variables of the log records of success rates of the team's effectiveness using the resource skills of the previous problems solved implies that the previously assigned work was assigned to a lower than required skill.

19. The computer program product according to claim 15, wherein a positive concession of the calculated net sum or deficit variables of the log records of success rates of the team's effectiveness using the resource skills of the previous problems solved implies that previously assigned work was assigned to a higher resource skill, thus identifying an overflow in skill for a particular workflow assignment of the previously assigned work.

20. The computer program product of claim 15, program instructions to modify the determined resource schedule based on altered conditions of the success rates of the one or more team's effectiveness in utilizing the resource skills over a duration of time.
